(19) United States
(12) Patent Application Publication
(10) Pub. No.: US 2001/0007983 A1
(43) Pub. Date: Jul. 12, 2001

(54) Method and system for transaction of electronic money with a mobile communication unit as an electronic wallet

(76) Inventor: Jong-II Lee, Koyang-City (KR)

Correspondence Address: Ajay A. Jagtiani, Jagtiani & Associates, Democracy Square Business Center, 10379-B Democracy Lane, Fairfax, VA, 22030, US

(21) Appl. No.: 09/796,827

(22) Filed: Mar. 2, 2001

(30) Foreign Application Priority Data
Dec. 15, 2000 (KR) PCT/KR00/01469
Dec. 28, 1999 (KR) 10-1999-063144

(51) Int. Cl. G06F 17/60

(52) U.S. Cl. 705/69; 705/64; 705/39

(57) ABSTRACT

A electronic monetary system comprising a mobile communication unit as an electronic wallet for transactions including electronic payments, money transfer, and recharging the electronic account.

The security of the electronic transactions is confirmed by circulating a confirmation number through a loop formed by an E-wallet managing server through the wireless network to the mobile communication unit of the user.

### FIELD OF THE INVENTION

The present invention relates to an electronic monetary system, and particularly to an electronic money transfer system including electronic wallet for secure electronic transactions and an operating method thereof.

### DESCRIPTION OF THE RELATED ART

The present invention relates to an electronic money system for implementing electronic money payment system as an alternative means to the conventional payment medium such as cash, checks, credit and debit cards.

The conventional credit card allows the internet user to make a purchase from a vendor simply by recording the credit card number and validation date on the cyber voucher displayed on the user's computer screen on the network.

However, since the disclosure of the credit card number and the user's information during the purchasing step is vulnerable to the attack from a hacker, the conventional credit card system is not adequate for an electronic commerce application.

Furthermore, since the youngsters under eighteen years of age are not allowed to be issued a credit card, the conventional credit card system is not appropriate for the kids to use for paying for the small items such as MP3 music file.

Furthermore, there is a tendency that the internet users dislike to use the credit card as a payment means especially for a small-size purchasing item because of the possibility of hacking problem.

To resolve the security issue of the conventional credit card system, an electronic monetary system employing an additional card with an encrypted number has been proposed. The following U.S. patents discloses the payment means and technique for electronic commerce on internet: U.S. Pat. No. 5,963,648, U.S. Pat. No. 5,920,629, and U.S. Pat. No. 5,953,423.

The prior art disclosed in the abovementioned U.S. patents can be categorized into two approaches: a card system and an encrypted number system. Since the card system of the prior art employs a magnetic card or an IC card, the sellers have to be provided with a specific card reader.

Moreover, it is inconvenient because the customer does not have an alternative way to check his balance of account other than the card reader. The conventional card system still lacks the security means against the hacker's attack.

As an another approach of the prior art, the encrypted number system employs a series of the encrypted number having 12^{˜}16 digits. The encrypted number system has merit in a sense that the encrypted number can be issued to a user instantly whenever the user applies for it.

However, the encrypted number system of the prior art still suffers from the shortcoming in that the user has to memorize a long number of 12^{˜}16 digits. Further, it is still difficult to tell the differences between the genuine user and the fake for a specific encrypted number under processing.

### SUMMARY OF THE INVENTION

In view of these problems, there is a need in the art for a secure and convenient electronic payment system, especially for an electronic money transfer on internet, which is not subject to these limitations.

Accordingly, it is an object of the present invention to provide an electronic money transfer system and method wherein the electronic commerce can be performed in a secure and convenient way.

It is further an object of the present invention to provide an electronic wallet and operating method wherein even small-size electronic commerce can be safely and conveniently performed.

Yet it is an object of the present invention to provide an electronic payment system including an electronic wallet that allows the user to perform transactions such as the issue, the recharge, the transfer, and the checking of the balance.

It is another object of the present invention to provide an electronic monetary system and method that allows the user to perform all kinds of electronic transactions on internet and/or wireless network.

It is further an object of the present invention to provide an electronic monetary system including a mobile communication unit that allows the user to conduct electronic commerce and transactions.

In accordance with a broad aspect of the present invention, provided is an electronic monetary system that comprises an ARS server, a payment managing server, a web page of the payment managing server for interfacing the customers, and a mobile communication unit as an electronic wallet.

The ARS server allows the user to open a new electronic account, to recharge the electronic account, and to check the balance of the electronic account. The E-wallet managing server manages the overall electronic commerce and transactions between buyers and sellers.

The unique feature of the present invention is that the genuine user of the current electronic transaction is confirmed under a procedure of circulating a certain confirmation number through a loop comprising the ARS server, the user's electronic wallet (preferably, the user's mobile communication unit) and the wireless network.

As a result, it becomes possible to implement a secure and convenient monetary system for electronic commerce and transactions on internet.

### BRIEF DESCRIPTION OF THE DRAWINGS

Further features of the present invention will become apparent from a description of the operating method and system taken in conjunction with the accompanying drawings of the preferred embodiment of the invention, which, however, should not be taken to be limitative to the invention, but are for explanation and understanding only.

In the drawings:

FIG. 1 is a schematic diagram illustrating the electronic monetary system in accordance with the present invention.

FIGS. 2A to 2D are schematic diagrams illustrating the workflow of opening a new electronic account in accordance with the preferred embodiments of the present invention.

FIGS. 3A to 3D are schematic diagrams illustrating the workflow of recharging the electronic account in accordance with the preferred embodiments of the present invention.

FIGS. 4A and 4B are schematic diagrams illustrating the workflow of transferring electronic money in accordance with the preferred embodiments of the present invention.

FIGS. 5A and 5B are schematic diagrams illustrating the workflow of an electronic purchasing scenario in accordance with the preferred embodiments of the present invention.

FIGS. 6A to 6C are schematic diagrams illustrating the workflow of checking the balance of the electronic account in accordance with the preferred embodiments of the present invention.

FIG. 7 is a schematic diagram illustrating the comprising blocks of a mobile communication unit as an electronic wallet in accordance with the present invention.

FIG. 8 is a schematic diagram illustrating the format of the SMS message transmitted from a mobile communication unit as an electronic wallet in accordance with the present invention.

FIGS. 9A and 9B are schematic diagrams illustrating the workflow of performing an electronic commerce with an electronic wallet in accordance with the present invention.

FIG. 10 is a schematic diagram illustrating the workflow of applying for the issue of a new electronic account with an electronic wallet in accordance with the present invention.

FIG. 11 is a schematic diagram illustrating the workflow of recharging the electronic account with an electronic wallet in accordance with the present invention.

### DETAILED DESCRIPTION OF THE PREFERRED EMBODIMENT OF THE INVENTION

The present invention will be explained in detail with reference to the accompanying drawings.

The present invention provides a method of electronic monetary transfer through an electronic wallet.

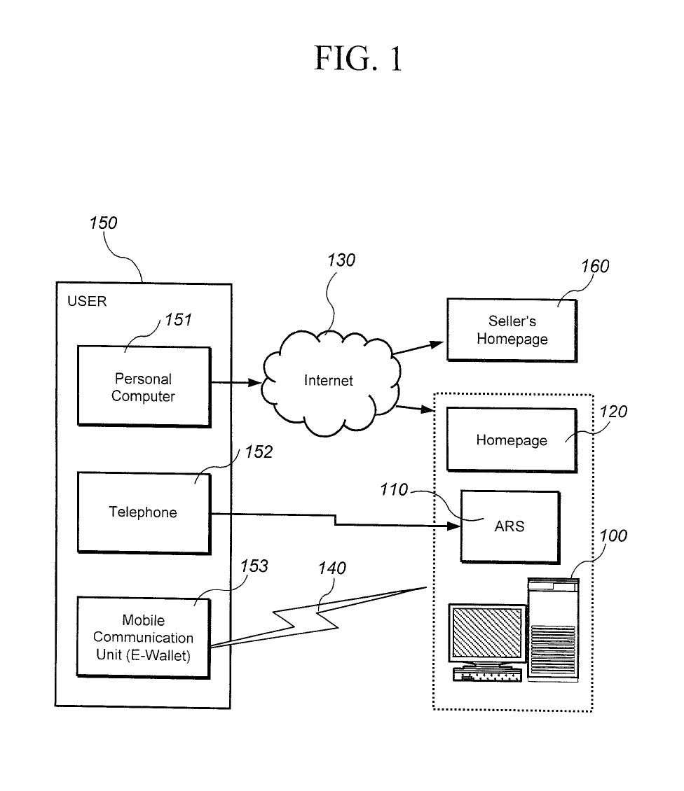

FIG. 1 is a schematic diagram illustrating the electronic monetary system in accordance with the present invention. Referring to FIG. 1, an E-wallet (electronic wallet) managing server 100, an ARS server 110, and a homepage 120 of the E-wallet managing server 100 are depicted.

The user 150 has an access to the E-wallet managing server 100 through the internet 130 or the wireless network 140 and performs electronic transactions such as opening a new electronic account, recharging the account, transforming between accounts, and checking the balance.

The user 150 also has an access either to the homepage 120 of the E-wallet managing server 100 or to the seller's homepage 160 to conduct an electronic commerce.

As a preferred embodiment according to the present invention, the user 150 can make a phone call to the ARS server 110 by his telephone unit 152 and perform various electronic transactions such as opening, recharging, transferring, and checking the balance of account.

More preferably, a mobile communication unit 153 can be used as an E-wallet for performing various electronic transactions such as opening the account, recharging the account, transferring money between accounts, and checking the valance of account.

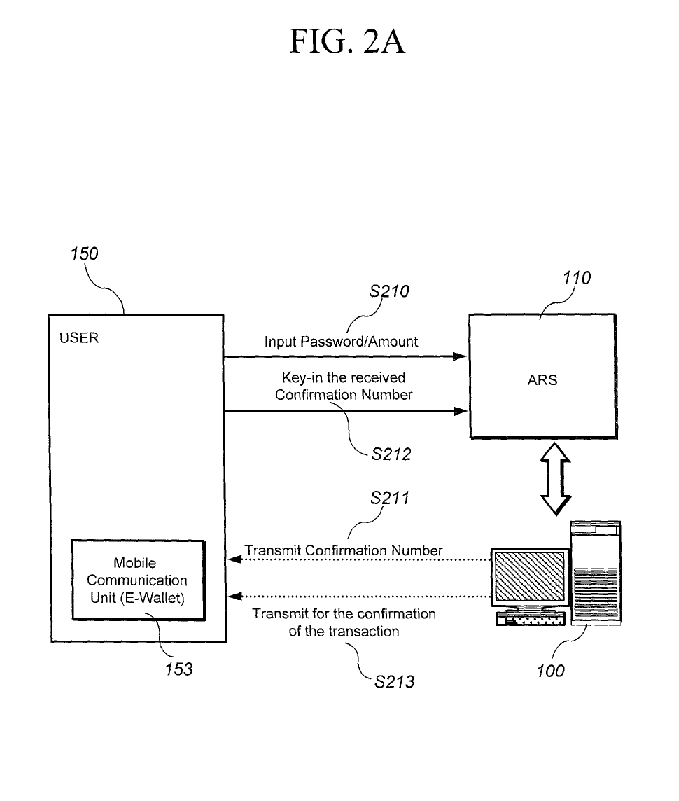

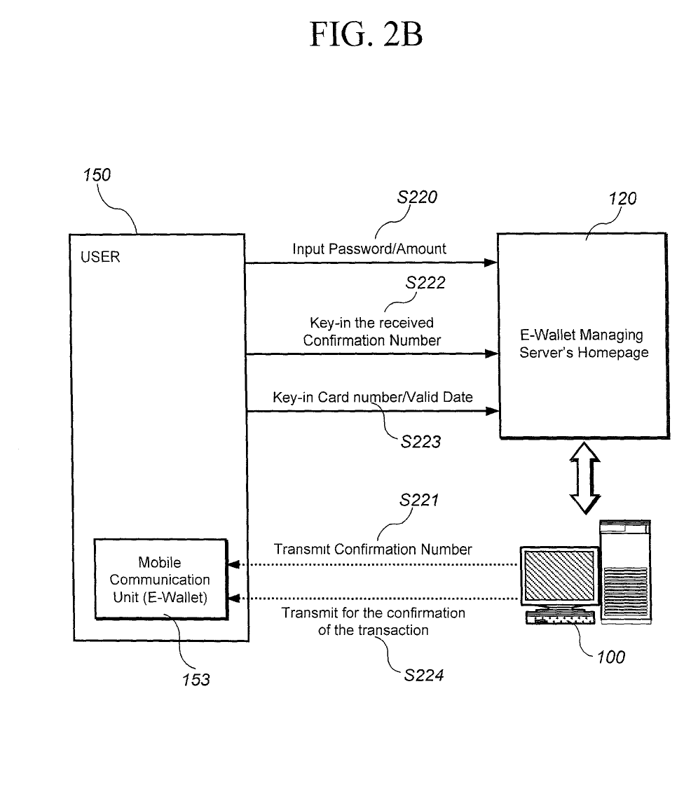

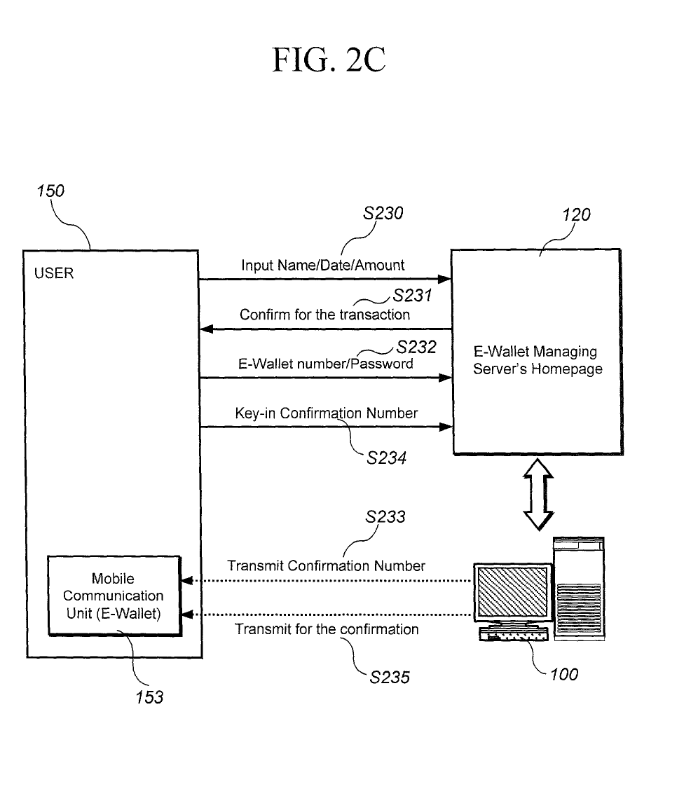

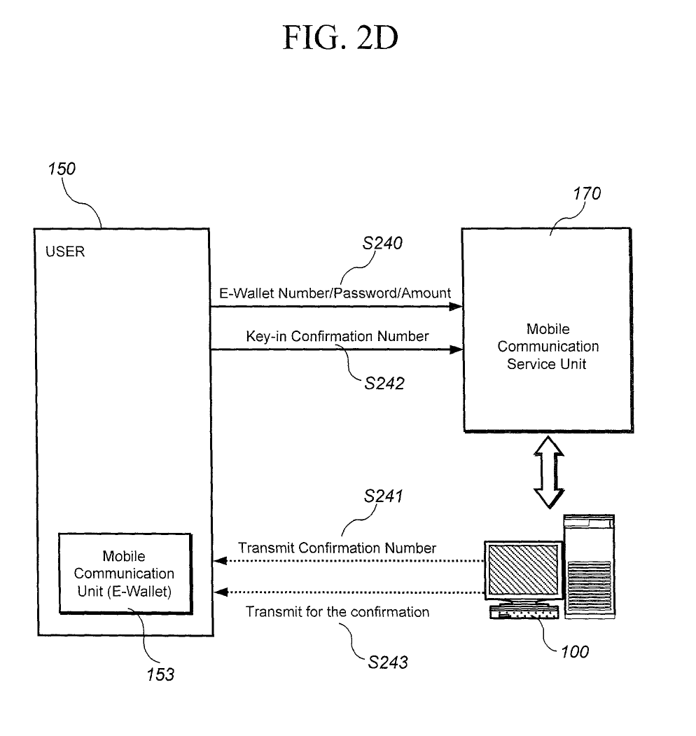

FIG. 2A is a schematic diagram illustrating the workflow of opening a new electronic account in accordance with a first embodiment of the present invention.

Referring to FIG. 2A, the user 150 makes a phone call to the ARS server 110 of the E-wallet managing company and keys in his phone number of the mobile communication unit 153, his password, and the amount of money to be initially deposited in his new account (step S210).

The ARS server 110 then sends a stream of a randomly generated confirmation number to the user's mobile communication unit (E-wallet; 153) through a wireless network (step S211). The confirmation number sent from the ARS server 110 is then displayed on the LCD monitor of the user's E-wallet 153.

After reading the confirmation number displayed on the display of his mobile communication unit, the user 150 enters the confirmation number by using the buttons on the keypad of his mobile communication unit in order to send back the confirmation number. The successful circulation of the confirmation number through the loop via the occupant of the mobile communication unit implies that the genuine user is applying for an electronic money account to the ARS server 110 (step S212).

Now, the randomly generated confirmation number has been circulated through a loop starting from the ARS server 110 through the user's E-wallet, and finally back to the ARS server 110.

In the case when the number entered on the user's ARS call (step S212) is exactly the same number as the one transmitted by the ARS server 110 on the wireless network, the requested transaction can be approved by the E-wallet managing server.

Finally, the E-wallet managing server 100 sends a message stating that the user's request for opening a new electronic account has be successfully performed (step S213).

The first embodiment of the present invention depicted in FIG. 1A discloses a technique of identifying a genuine user by circulating a confirmation number from the server 110 through the E-wallet 153 to the user's ARS phone network.

Now, the user 150 can conduct an electronic commerce on internet with his electronic money account. The amount of money the user has requested in the transaction now can be added to the total of the monthly invoice billed by the company of telephone service, for example.

FIG. 2b is a schematic diagram illustrating the workflow of opening a new electronic account in accordance with a second embodiment of the present invention.

Referring to FIG. 2b, the user 150 can visit the homepage 120 of the E-wallet managing server 100 in accordance with the present invention and request to open a new electronic account on internet.

The user can enter the information about the phone number of his mobile communication unit (i.e. E-wallet) 153, his password, and the requested amount of money for his new electronic account (step S220) on internet.

The E-wallet managing server 100 transmits a confirmation number (step S221) to the mobile communication unit (or an E-wallet) identified by the phone number that the user entered at a step of S220.

The user 150 now reads the confirmation number displayed on the screen of his E-wallet 153 and enters the received confirmation number in the appropriate box provided on the E-wallet managing server's homepage 120 (step S222).

Now, the request for a new electronic monetary account has been securely validated through a successful circulation of the confirmation number.

Thereafter, the user 150 can choose either a credit card or a debit card for his payment means (step S223). Namely, the user 150 can enter his credit card number with the validation date at a step of S223.

The user can expect to receive an invoice later next month for the requested transaction of the electronic money in his new account.

As a preferred embodiment in accordance with the present invention, the confirmation message sent to the user's E-wallet 153 can include the balance of account, and/or the amount of the issued electronic money through SMS (short message service) means at step S224.

FIG. 2c is a schematic diagram illustrating the workflow of opening a new electronic monetary account in accordance with a third embodiment of the present invention.

Referring to FIG. 2c, the user 150 can open a new electronic account by transferring money from a bank account. Namely, the user 150 can provide information about the name of the sender, date of transfer, and the amount of transfer in the web page 120 of the E-wallet managing server 100 (step S 230) after sending the money to an account of the company of the E-wallet managing server.

The E-wallet managing server 100 confirms the transfer of money for opening a new electronic account (step S231). Then the user 150 enters the phone number of his mobile communication unit (E-wallet) and password in the appropriate box provided by the homepage 120 of the E-wallet managing server 100 (step S232).

Thereafter, the confirmation process in accordance with the present invention is followed. Namely, a randomly generated confirmation number is transmitted (step S233) to a mobile communication unit (E-wallet; 153). Then the user enters the confirmation number in the box of the homepage 120 by referring to a stream of numbers displayed on the screen of the user's E-wallet 153 (step S234).

Finally, the E-wallet managing server 100 transmits an SMS message advising the confirmation for the completion of the requested transaction to the E-wallet 153 of the user (step S235).

FIG. 2D is a schematic diagram illustrating the workflow of opening a new electronic monetary account in accordance with a fourth embodiment of the present invention.

Referring to FIG. 2D, the fourth embodiment of the invention discloses a technique wherein the company for mobile communication service sends a bill to the user for the electronic money. In the meanwhile, the first embodiment, depicted in FIG. 2A, is related to a scheme wherein the company of ARS telephone service sends a bill for the electronic money.

Referring to FIG. 2D, the user 150 supplies the information about the phone number of his E-wallet 153, password, and the requested amount of electronic money to the mobile communication service system 170 (step S240).

In this case, the phone number of the user's E-wallet does not have to be entered by the user on the keypad because the mobile communication unit 153 is distinguishable by the company of mobile communication service.

Thereafter, the E-wallet managing server 100 transmits a randomly chosen confirmation number to the mobile communication unit or the E-wallet 153 through a wireless communication network (step S241).

Referring to the confirmation number displayed on the screen of the mobile communication unit or the E-wallet 153, the user 150 can return the confirmation number to the mobile communication service unit 170 in order to complete the confirmation loop in accordance with the present invention.

Finally, the mobile communication service system 170 can transmit an SMS message stating the confirmation of the service rendered (step S243).

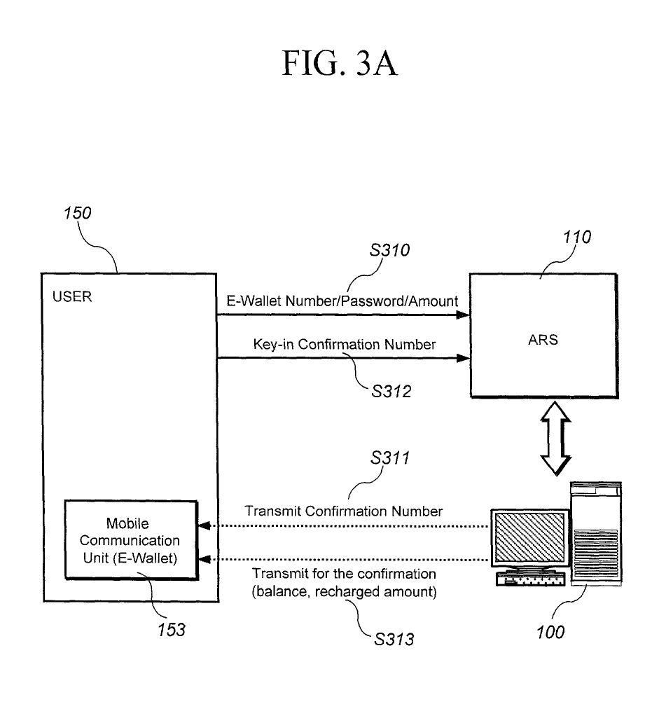

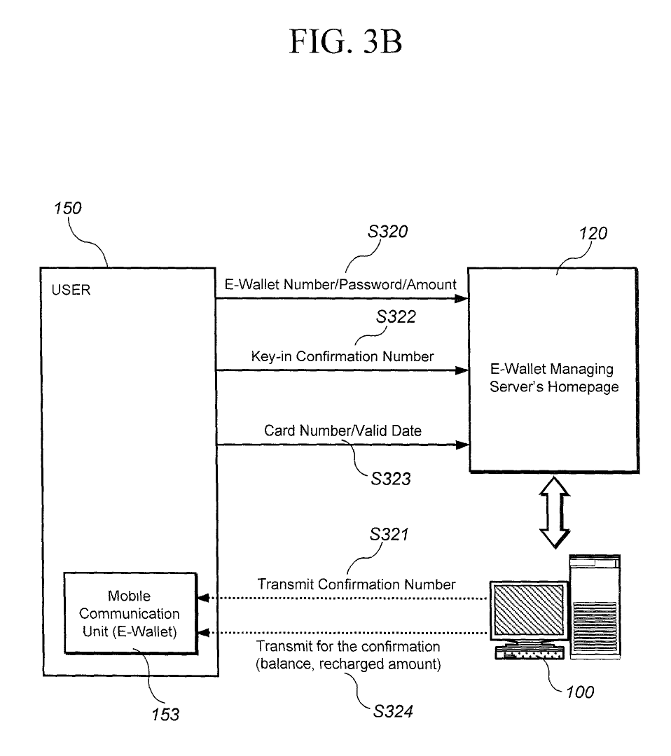

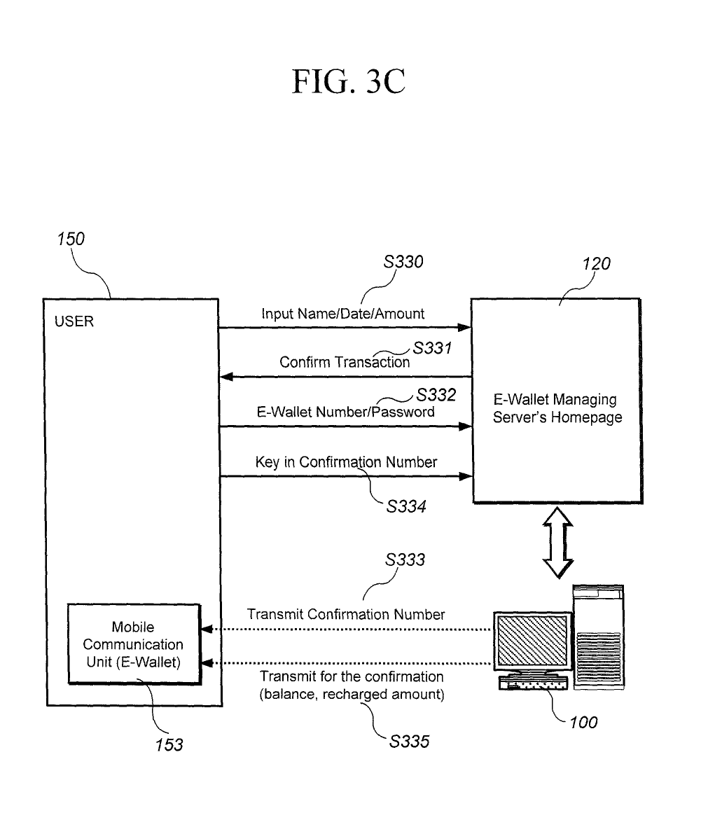

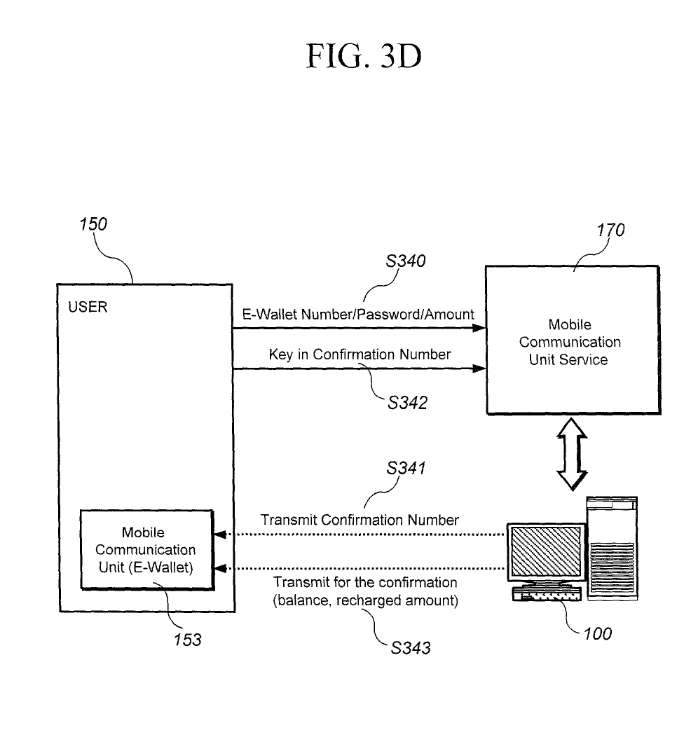

FIG. 3A is a schematic diagram illustrating the workflow of recharging an electronic account in accordance with a fifth embodiment of the present invention.

The fifth embodiment of the present invention relates to a technique to recharge a certain amount of money to an electronic account while the company of the ARS communication service sends a bill corresponding to the recharged money later.

The electronic money that the user 150 has in his electronic account can be used for the electronic commerce like purchasing in an internet shopping mall and the electronic account can be recharged with the electronic money by several methods depicted in FIGS. 3A to 3D.

Referring to FIG. 3A, the recharging process in accordance with the fifth embodiment of the invention is similar to the opening process of a new electronic account depicted in FIG. 2A except for the entrance of the E-wallet number and the password just for the confirmation because the account is already opened.

Finally, the ARS server 110 can send an SMS message to the E-wallet 153 for notifying the balance of the account or the recharged amount of electronic money (step S313).

FIG. 3B is a schematic diagram illustrating the workflow of recharging an electronic account in accordance with a sixth embodiment of the present invention.

Referring to FIG. 3B, the electronic account is recharged with electronic money by making payments through the conventional credit card or the debit card.

FIG. 3C is a schematic diagram illustrating the workflow of recharging an electronic account in accordance with a seventh embodiment of the present invention.

Referring to FIG. 3C, the electronic account in recharged with electronic money by bank transfer, which is based on the third embodiment disclosed in FIG. 2C.

FIG. 3D is a schematic diagram illustrating the workflow of recharging an electronic account in accordance with an eighth embodiment of the present invention.

Referring to FIG. 3D, the electronic account is recharged with a certain amount of electronic money by adding the recharged amount of money to the bill from the company of mobile communication service, which is based upon the fourth embodiment depicted in FIG. 2D.

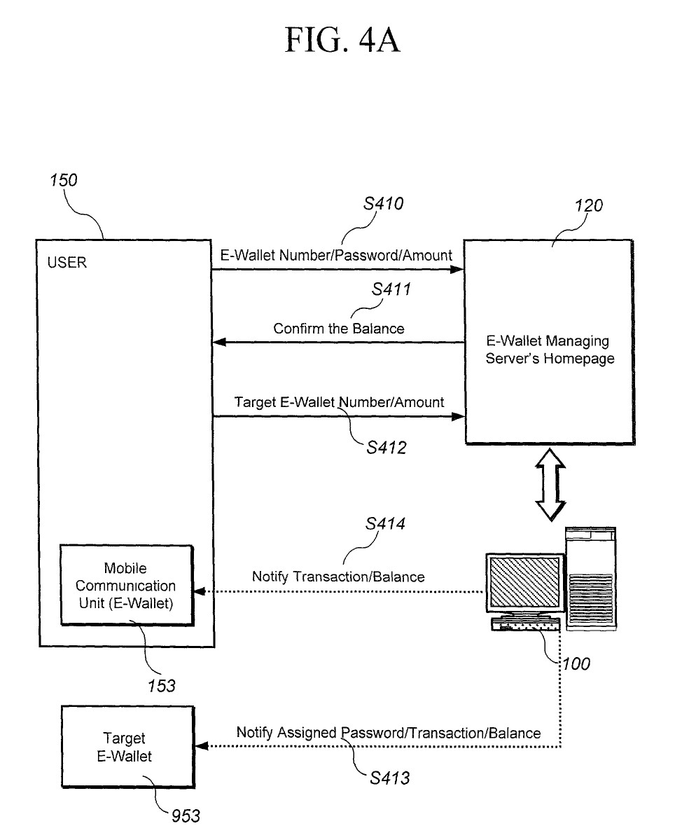

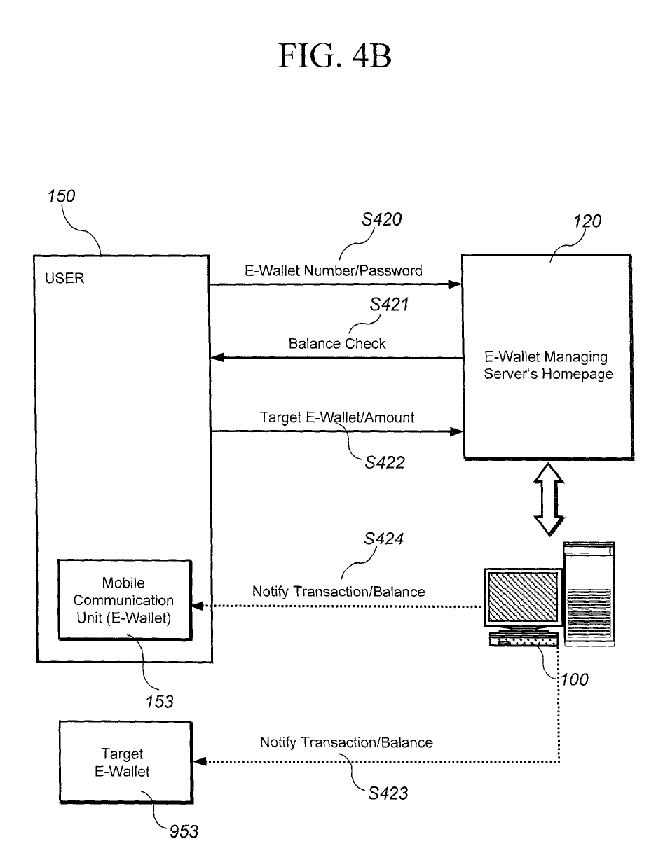

FIG. 4A is a schematic diagram illustrating the workflow of transferring a certain amount of electronic money to a designated electronic account (target account) in accordance with a ninth embodiment of the present invention.

Referring to FIG. 4A, the ninth embodiment discloses a technique that is applicable to a case when the receiver of the transferred money dose not have an electronic account at a time of money transfer.

First of all, a first user (sender; 150) enters his E-wallet number or the phone number of his mobile communication unit, his password, and the amount of money he wants to transfer in the box of the E-wallet managing server's homepage 120 (Step S410) on internet.

Then the E-wallet managing server 100 responds to the request of money transfer by advising the first user (sender; 150) of the balance of account (step S411).

After examining the current balance of account, the sender 150 enters the E-wallet number of a second user (receiver; 953) and the amount of money transfer (step S412) on the web page of the E-wallet managing server.

Thereafter, the E-wallet managing server 100 opens a new electronic account for the receiver (a second user) designated by the phone number of the target E-wallet 953 and assigns an arbitrary password to the new account.

The E-wallet managing server 100 advises the receiver of the money transfer including the assigned password and the balance of account on a wireless network (step S413).

In addition, as a preferred embodiment in accordance with the present invention, the details of the money transfer can be sent to the first user's E-wallet 153, more preferably through an SMS message.

FIG. 4B is a schematic diagram illustrating the workflow of transferring a certain amount of electronic money to a designated electronic account (target account) in accordance with a tenth embodiment of the present invention.

Referring to FIG. 4B, the tenth embodiment discloses a technique that is applicable to a case when the receiver of the transferred money already has an electronic account.

The distinct difference between the ninth embodiment and the tenth embodiment is that the E-wallet managing server 100 does not have to assign the password during the process for money transfer to the recipient (step S423).

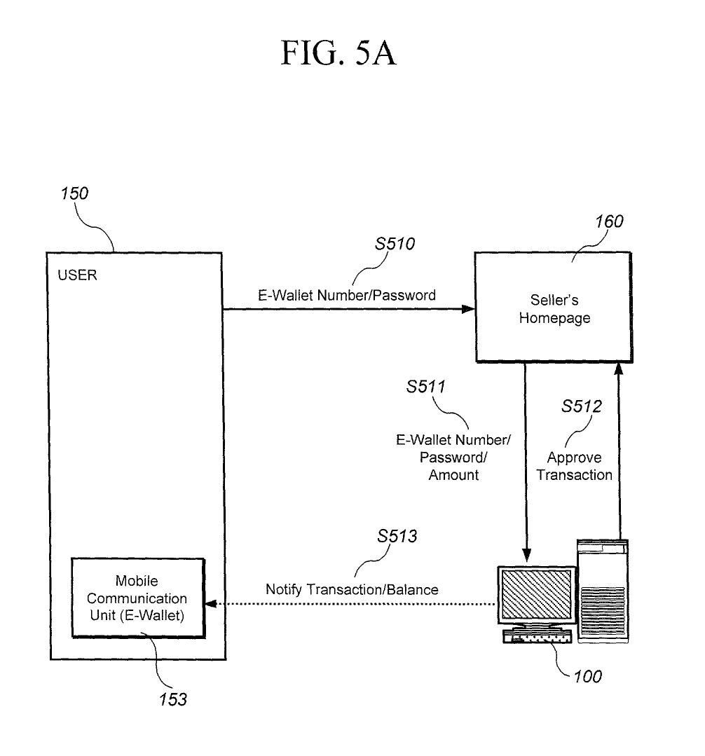

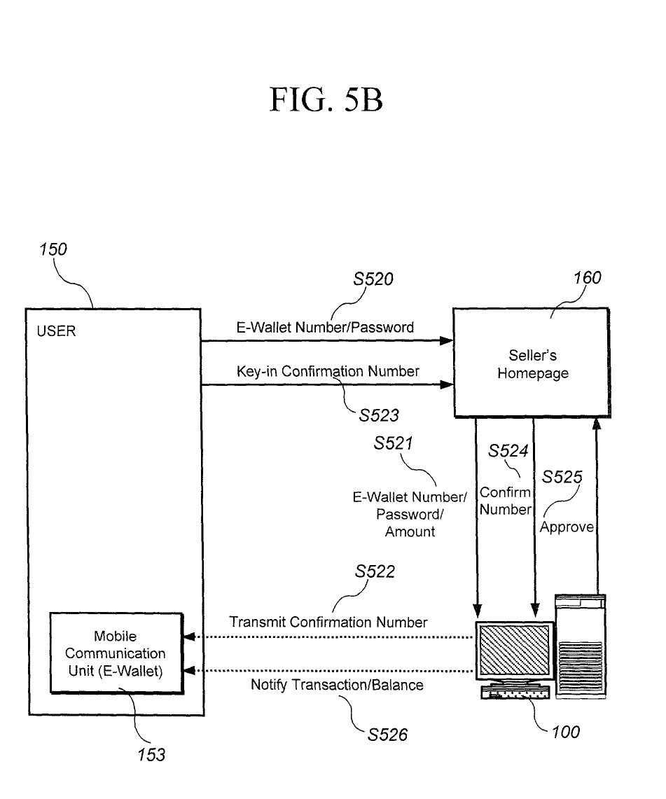

FIG. 5A is a schematic diagram illustrating the workflow of conducting an electronic commerce by using the electronic money in accordance with an eleventh embodiment of the present invention.

Referring to FIG. 5A, the user 150 visits the seller's homepage 160 (for example, internet shopping mall) and provides his E-wallet number or the phone number of his mobile communication unit, and password (step S510). The web server of the seller's homepage 160 then sends a message including a request for approval with the buyer's 150 E-wallet number and password to the E-wallet managing server 100 (step S511).

Thereafter, the E-wallet server 100 responds to the request for approval (step S512), and the user 150 is now able to continue the purchasing process from the seller.

Finally, the E-wallet managing server 100 can inform the user 150 of the details of transaction and the balance of account on an SMS message.

FIG. 5B is a schematic diagram illustrating the workflow of conducting electronic commerce in accordance with a twelfth embodiment of the present invention.

Referring to FIG. 5B, the twelfth embodiment has a feature in a sense that confirming steps S522, S523, and S524 for a secure electronic commerce are further added to the scheme disclosed in the eleventh embodiment of the invention.

The user 150 visits the seller's homepage 160 and enters his E-wallet number and password (step S520) on the web page. The web server of the seller's homepage 160 then transmits the purchase request for approval with the buyer's 150 E-wallet number and password to the E-wallet managing server 100 (step S521)

Thereafter, the E-wallet server 100 randomly generates a confirmation number and sends a message including the confirmation number to the E-wallet 153 on a wireless network (step S522).

The user 150 then enters the confirmation number in the appropriate box in the seller's homepage 160 by referring to the message displayed on his E-wallet (step S523).

The web server (not shown) of the seller's homepage 160 sends the confirmation number to the E-wallet managing server 100 (step S524) in order to get an approval from the server 100 (step S525).

Now the circulation of the confirmation number has been entirely completed, which implies a secure electronic commerce by a genuine purchaser.

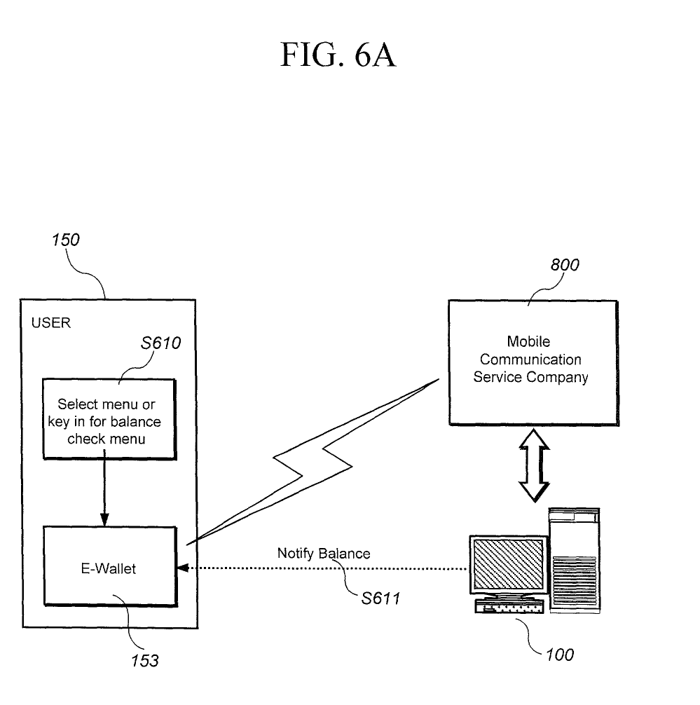

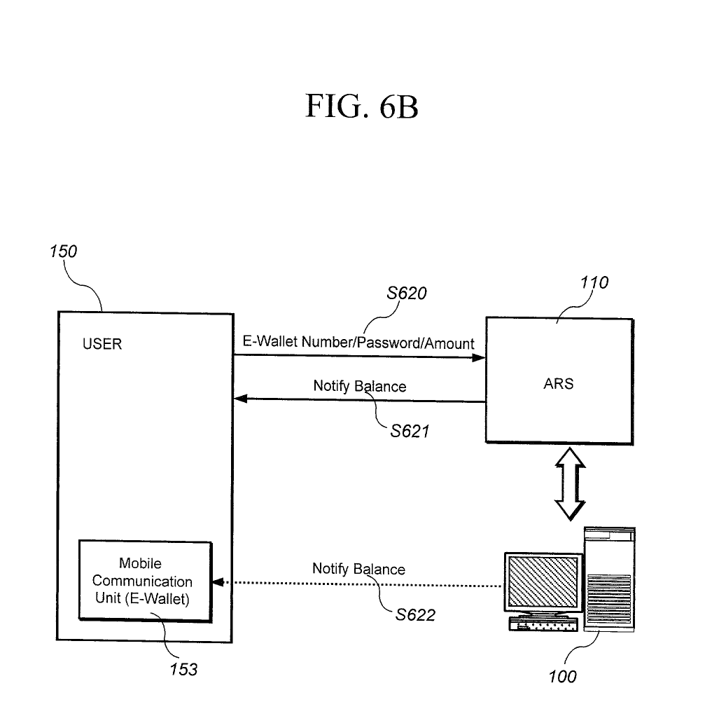

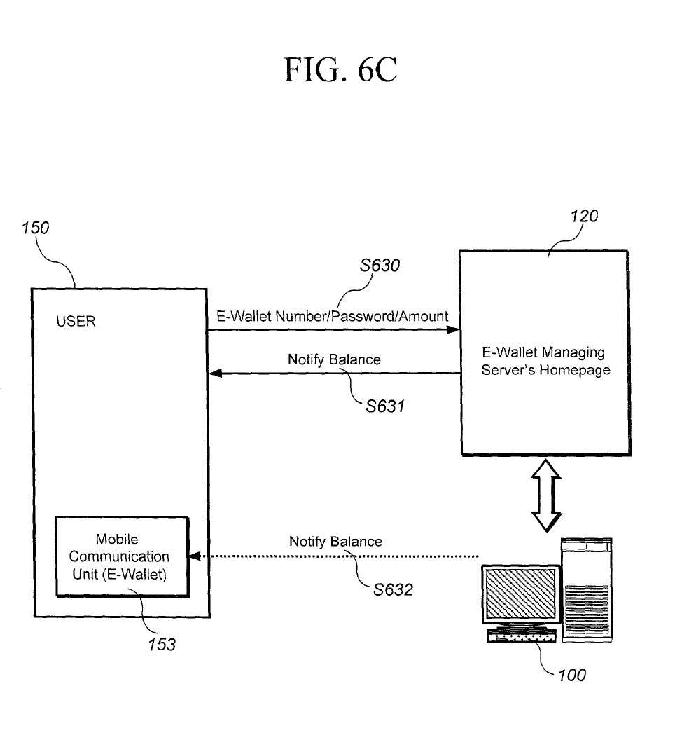

FIG. 6A is a schematic diagram illustrating the workflow of checking the balance of account in accordance with a thirteenth embodiment of the present invention.

Referring to FIG. 6A, the user 150 can select a menu or push a button for the inquiry of the balance of account (step S610)by using his mobile communication unit or his electronic wallet. More preferably, the keypad of the mobile communication unit (E-wallet; 153) can include a functional menu or a button for the inquiry of the balance of account.

At this time, the E-wallet 153 transmits a request for the balance of account with phone number and password to the company of mobile communication service 800.

Thereafter, the company of mobile communication service 800 delivers the request for the balance of account to the E-wallet managing server 100 through internet.

Consequently, the E-wallet managing server 100 sends a message (more preferably, SMS) including the balance of account to the E-wallet of the user 153 (step S611).

FIG. 6B is a schematic diagram illustrating the workflow of checking the balance of account in accordance with a fourteenth embodiment of the present invention.

Referring to FIG. 6B, the fourteenth embodiment discloses a scheme for checking the balance of account via ARS system. The user 150 makes an ARS call and enters his E-wallet number and password (step S620).

The ARS server 110 now responds to the request either by advising the user of the balance (step S621) on the ARS phone or by an SMS message (step S622) to the E-wallet 153 on a wireless network.

FIG. 6C is a schematic diagram illustrating the workflow of checking the balance of account in accordance with a fifteenth embodiment of the present invention.

Referring to FIG. 6C, the user 150 visits the homepage 120 of the E-wallet managing server and enters his E-wallet number and password (step S630).

Then the E-wallet managing server's homepage advises the user of the balance (step S631). Moreover, the E-wallet managing server's homepage can inform the user of the balance through an SMS message (step S632).

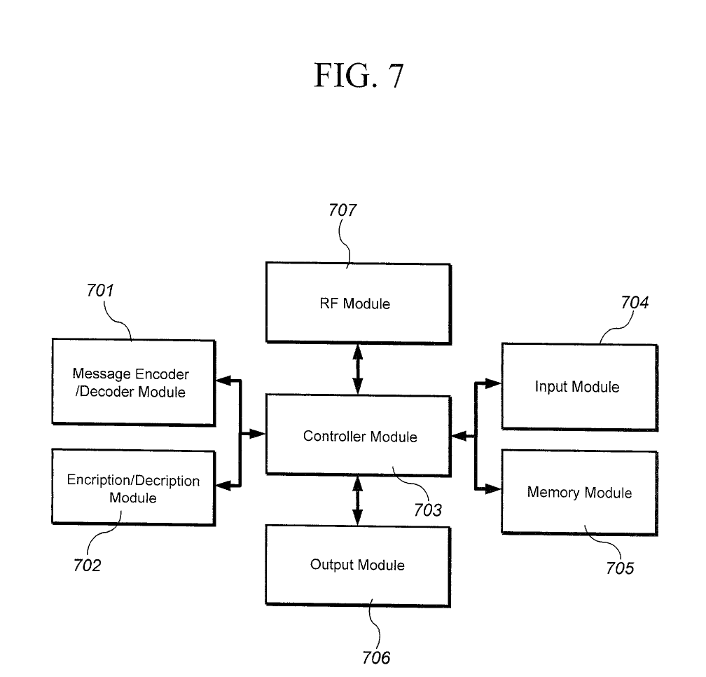

FIG. 7 is a schematic diagram illustrating the blocks of an E-wallet in accordance with the present invention. Referring to FIG. 7, a mobile communication unit as an electronic wallet 153 comprises a message encoder/decoder module 701, an encryption/decryption module 702, a controller module 703, input module 704, a memory module 705, output module 706, and an RF module 707.

The memory module 705 in accordance with the present invention stores the information about the balance of the electronic money account and the password of the user. The output module 706 in accordance with the present invention can comprise a LCD monitor.

The encoder/decoder module 701 translates the SMS message from/to the E-wallet managing server 100 in order to store the information about the transactions of the electronic account in the memory module 705.

The encryption/decryption module 702 performs the encryption and/or decryption process of the message for secure communication. The input module 704 in accordance with the present invention can include either functional key or a menu for electronic commerce.

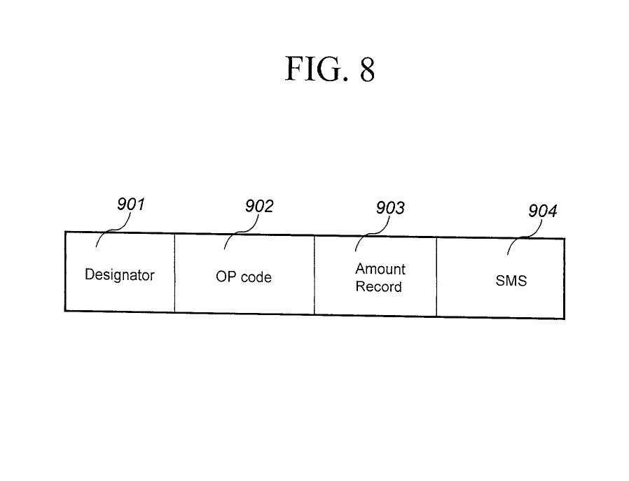

FIG. 8 is a schematic diagram illustrating the format of an SMS message for electronic account in accordance with the present invention.

Referring to FIG. 8, the data format employed by an E-wallet in accordance with the invention comprises a designator 901, an OP code 902 for changing the state of the E-wallet, an indicator 903 for an amount of electronic money, and an SMS message 904.

The designator 901 is a kind of header for designating that the current data is formatted for the use as an E-wallet. The OP (operand) code 902 in accordance with the present invention plays a role in changing the state of the E-wallet, i.e. entry mode, output mode, and correction mode, etc.

The amount indicator 903 implies an amount of money for a specific transaction. The SMS message 904 corresponds to a sentence “the amount of $100 has been deposited to your account from Mary,” for instance.

As another preferred embodiment of the present invention, the data can comprise a designator 901 for an E-wallet, an OP code 902 for transactions including checking the balance, money transfer, opening an account, and recharging the account, the amount indicator 903, an SMS message 904 corresponding to the OP code.

The SMS message 904 can include a sender's name and phone number, etc.

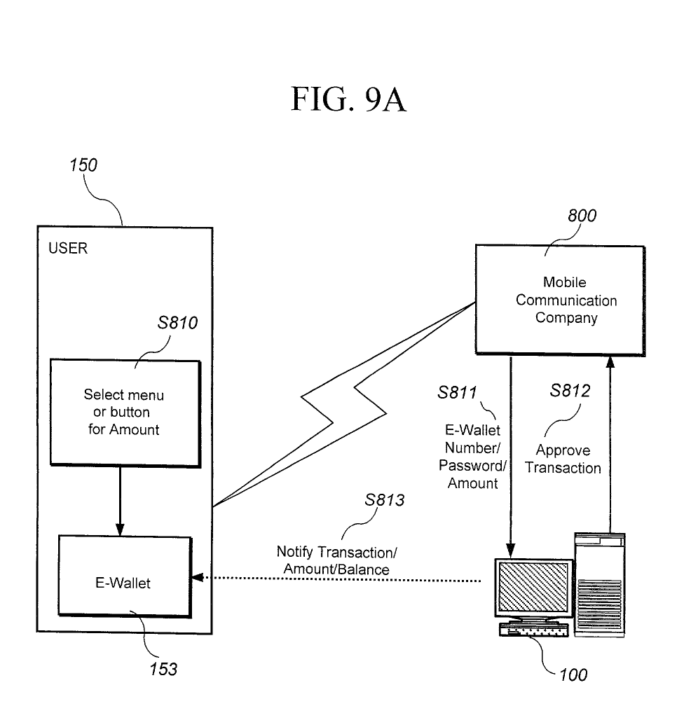

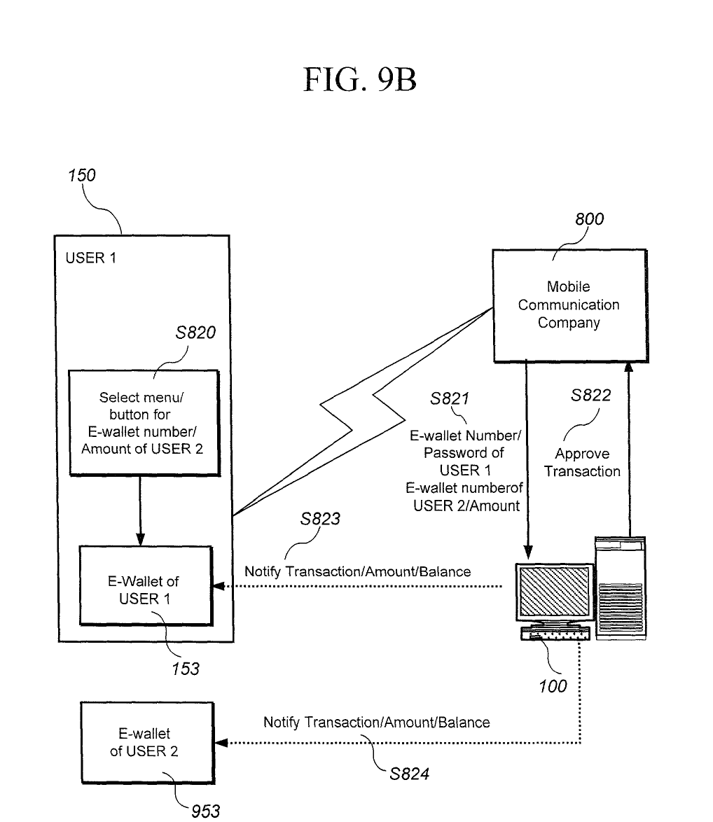

FIGS. 9A and 9B are schematic diagrams illustrating the workflow of performing an electronic commerce with an electronic wallet in accordance with the invention.

Referring to FIG. 9A, the sixteenth embodiment of the invention discloses a scheme for opening a new account or charging the account with the E-wallet.

The user 150 enters the amount of electronic money through a keypad or a menu of his E-wallet (step S810). Thereafter, the E-wallet 153 encodes the password fetched from the memory module 705 together with the entered amount of electronic money, and sends the encoded data to the server 800 of a mobile communication company.

As a consequence, the server 800 of a mobile communication company sends the E-wallet number, password, and the requested amount of electronic money to the E-wallet managing server 100 (step S811).

The E-wallet managing server 100 approves the transaction (step S812) and notifies the details of transaction such as the amount of money and the balance of the account (step S813).

FIG. 9B is a schematic diagram illustrating the workflow of performing an electronic commerce with an E-wallet in accordance with a seventh embodiment of the present invention.

Referring to FIG. 9B, a first user (sender; 150) can provide the E-wallet number of a second user (receiver; 953) and the amount of money to be transferred by selecting an appropriate menu or pushing a button on the keypad of the E-wallet of the first user 150 (step S820).

The information including the password, the requested amount of money, and the E-wallet number of the second user 953 are then fetched and encoded from the memory module 705 of the E-wallet of the first user 153 and transmitted to the mobile communication company 800.

The server of the mobile communication company 800 now sends the information for an electronic transaction including the E-wallet number of the first user (sender) 150, password, the requested amount of money transferred, the E-wallet number of the second user (receiver) 953 to the E-wallet managing server 100 (step S821).

The E-wallet managing server 100 approves the requested electronic transaction from the mobile communication company 800 (step S822), and then sends the notifying signals to both the sender's E-wallet and the receiver's E-wallet advising the completion of the requested electronic transaction (step S823 and step S824).

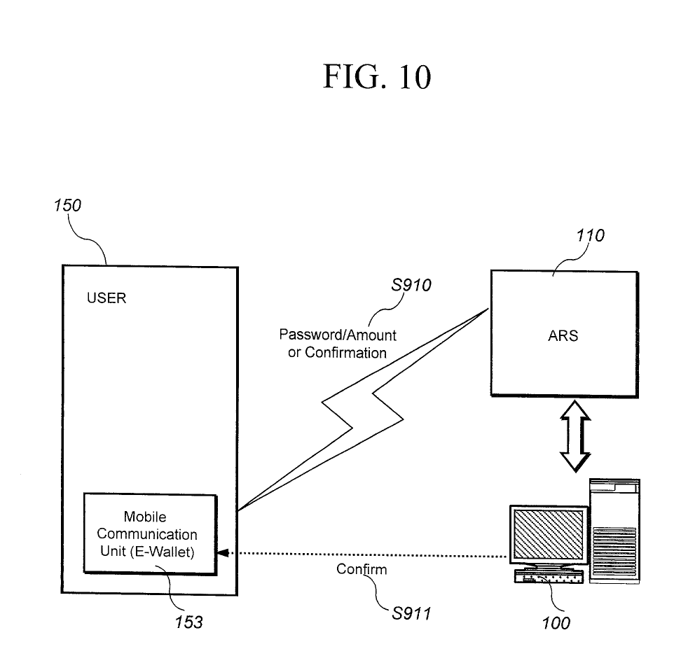

FIG. 10 is a schematic diagram illustrating the workflow of opening a new electronic account with an electronic wallet in accordance with the eighteenth embodiment of the present invention.

Referring to FIG. 10, the E-wallet of the user 150 sends the signal including password and the requested amount of money for a new account to the ARS server 110 (step S910).

Preferably, the user does not have to provide his E-wallet number in accordance with the eighteenth embodiment of the present invention.

According to the eighteenth embodiment of the invention, a process of circulating the confirmation number through a loop disclosed in the first embodiment depicted in FIG. 2 can be omitted because the occupancy of the E-wallet 153 has already been verified.

Therefore, the ARS server 100 can open a new electronic account from the information including the E-wallet number and the password, and then deposit the requested electronic money into the new account.

Finally, the ARS server 100 transmits a message stating the completion of the requested transaction (step S911).

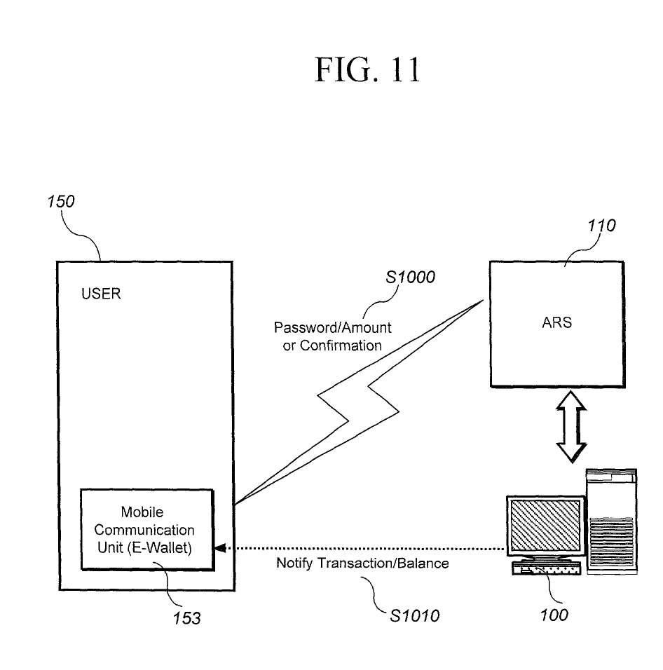

FIG. 11 is a schematic diagram illustrating a recharging process with an E-wallet in accordance with the nineteenth embodiment of the invention.

Referring to FIG. 11, the user 150 enters the requested amount of money to be recharged and the password into his E-wallet by selecting a menu or by pushing the appropriate button on the keypad (step S1000).

Then, the information provided by the user 150 is transmitted to the ARS server 110. The ARS server 110 then recharges the user's electronic account with the requested amount of money after verification of the genuine user and finally notifies the transaction with the updated balance of account (step S1070).

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

What is claimed is:

1. A method for an E-wallet managing server to issue a certain amount of electronic money to a user, comprising steps of:
taking the data including the phone number of the user's mobile communication unit, the password, and the requested amount of electronic money, which the user provided on the user's ARS call to the ARS server of said E-wallet managing server;
sending a message including a confirmation number generated by said E-wallet managing server to said user's mobile communication unit on a wireless network;
fetching the confirmation number that the user entered on his ARS call to the ARS server of said E-wallet managing server according to the number displayed on the display of his mobile communication unit;
opening a new electronic account designated by the phone number of the user's mobile communication unit and the password, and then depositing the request amount of electronic money to the new electronic account for the user after verifying the validity by comparing between the fetched confirmation number entered on the ARS call with the confirmation number initially transmitted to the user's mobile communication; and
informing the user's mobile communication unit of the completion of the requested transaction.

2. A method for an E-wallet managing server to issue an amount of electronic money to a user, comprising steps of:
taking the data including the phone number of the user's mobile communication unit, the password, and the request amount of electronic money, which the user provided on the web page of said E-wallet managing server;
sending a message including a confirmation number generated by said E-wallet managing server to the user's mobile communication unit;
fetching a confirmation number that the user entered on the web page of the E-wallet managing server with reference to the number displayed on the display of his mobile communication unit;
opening a new electronic account designated by the phone number of the user's mobile communication unit, the password, and then depositing the requested amount of electronic money to the new electronic account for the user after verifying the validity of the fetched confirmation number entered on the web page by comparing the fetched number with the confirmation number initially transmitted to the user's mobile communication unit; and
informing the user's mobile communication unit of the completion of the requested transaction.

3. A method for an E-wallet managing server to issue an amount of electronic money to a user, comprising steps of:
taking the data including the phone number of the user's mobile communication unit, the password, the name/data/amount of money transferred into the bank account under the E-wallet managing server, which the user provided on the web page of said E-wallet managing server;
checking the name/data/amount of money transferred into the bank account under the E-wallet managing server;
sending a message including a confirmation number generated by said E-wallet managing server to the user's mobile communication unit;
fetching a confirmation number that said user entered on the web page of said E-wallet managing server with reference to the number displayed on the display of the user's mobile communication unit;
opening a new electronic account designated by the phone number of the user's mobile communication unit, the password, and then depositing said requested amount of electronic money to said new electronic account for said user after verifying the validity of the fetched confirmation number on the web page with comparison to the confirmation number initially transmitted to the user's mobile communication unit; and
informing the user's mobile communication unit of the completion of the transaction that the user requested.

4. A method for an E-wallet managing server to issue an amount of electronic money to a user on a network, comprising steps of:
taking the data including the password of the user and the requested amount of electronic money, which were transmitted from the user's mobile communication unit having a function of electronic wallet;
opening a new electronic account designated by the phone number of the user's mobile communication unit, the password, and then depositing the requested amount of electronic money to the new electronic account for said user after verifying the validity of the fetched confirmation number on the web page with comparison to the confirmation number initially transmitted to the user's mobile communication unit; and
advising the user's mobile communication unit of the completion of the transaction that the user requested.

5. The method for an E-wallet managing server to issue an amount of electronic money as claimed in claim 1, 2, 3, or 4 wherein said opening step of a new electronic account includes a step of recharging the electronic account with the requested amount of electronic money.

6. The method for an E-wallet managing server to issue an amount of electronic money as claimed in claim 1, 2, 3, or 4 wherein said advising step includes a step of sending to the user's mobile communication unit either one or a combination from the group comprising the balance of the electronic account, the issued amount of electronic money, and the recharged amount of money.

7. A method for an E-wallet managing server to control the electronic money transfer from a first user's account to a second user's account, comprising steps of:
taking the data including the phone number of the first user's mobile communication unit and the first user's password, which the first user provided on the web page of said E-wallet managing server;
notifying the balance of the first user's account to the first user on the web page of said E-wallet managing server;
taking the data including the phone number of the second user's mobile communication unit and the requested amount of money to be transferred, which the first user provided on the web page of said E-wallet managing server;
performing a money transfer from the first user's account designated by the phone number of the first user's mobile communication unit, to the second user's account designated by the phone number of the second user's mobile communication unit; and
sending messages including the balance of account to each mobile communication unit of both users after the requested transaction, respectively.

8. A method for an E-wallet managing server to control the electronic money transfer from a first user's account to a second user's account, comprising steps of:
taking the data including the phone number of the first user's mobile communication unit and the first user's password, which have been sent from the first user's mobile communication unit having a function of electronic wallet wherein the first user enters his password either on keypad or by menu;
sending a message including the balance of the first user's account to the mobile communication unit of the first user;
taking the data including the phone number of the second user's mobile communication unit and the requested amount of money to be transferred, which have been provided by the first user and sent from the first user's mobile communication unit having a function of electronic wallet;
performing a money transfer from the first user's account designated by the phone number of the first user's mobile communication unit, to the second user's account designated by the phone number of the second user's mobile communication unit; and
sending a message including the balance of account to each mobile communication unit of both users, respectively, after the requested transaction.

9. The method as claimed in claim 7 or claim 8 wherein said step of sending a message including the balance of account after transaction comprises a steps of:
assigning a password arbitrarily to the second user's account designated by the phone number of the second user's mobile communication unit if the second user does not have an electronic account; and
sending a message including the balance of account and the arbitrarily assigned password to the second user's mobile communication unit if the second user is a new customer to the E-wallet managing server.

10. The method as claimed in claim 7 or claim 8 wherein said E-wallet managing server further comprises an ARS server and a web server.

11. The method as claimed in claim 7 wherein said step of taking the data including the phone number of the first user's mobile communication unit and the first user's password further comprises steps of:
sending a confirmation number to the mobile communication unit of the first user;
taking the confirmation number, returned from the first user, which the first user provided on the web server page of said E-wallet managing server in accordance with the received confirmation number displayed on the display of the mobile communication unit; and
verifying the returned confirmation number with reference to the confirmation number that was initially transmitted to the mobile communication unit of the first user.

12. A method for an E-wallet managing server to manage an electronic commerce between a buyer and a seller, comprising steps of:
taking the data including the phone number of the buyer's mobile communication unit, the buyer's password, and the requested amount of money to be paid for a purchase item, which are sent from the seller's web server after the buyer provides the data including the phone number of his mobile communication unit, password, and a purchasing item on the seller's web page;
sending an approval message to the seller's web server and deducting the requested amount of money from the buyer's account designated by the phone number of the buyer's mobile communication unit; and
sending a message including the details of the transaction and the balance of electronic money account designated by the phone number of the seller's mobile communication unit.

13. A method for an E-wallet managing server to manage an electronic commerce between a buyer and a seller, comprising steps of:
taking the data including the phone number of the buyer's mobile communication unit, the buyer's password, and the requested amount of money to be paid for a purchasing item, which are sent from the seller's web server after the buyer provides the data including the phone number of the buyer's mobile communication unit, password, and a purchasing item on the seller's web page;
sending a confirmation number to the buyer's mobile communication unit;
taking a returned confirmation number from the seller's web server, which the buyer has entered on the seller's web page in accordance with the received confirmation number displayed on the display of the buyer's mobile communication unit;
verifying the returned confirmation number with comparison to the confirmation number initially sent to the buyer's mobile communication unit;
sending an approval message to the seller's web server and deducting the requested amount of money from the buyer's account designated by the phone number of the buyer's mobile communication unit; and
sending a message including the details of the transaction and the balance of electronic money account designated by the phone number of the seller's mobile communication unit.

14. A method for an E-wallet managing server to inform the user of the balance of electronic money in the user's account designated by the phone number of the user's mobile communication unit and the password, comprising steps of:
receiving a request for informing the user of the balance of electronic money in the user's account from the user's mobile communication unit when the user either pushes a balance inquiry button on the keypad or selects a balance inquiry menu of the user's mobile communication unit;
referring to the balance of the user's account designated by the phone number of the user's mobile communication unit and the user's password; and
sending a message including the referred balance of the user's account to the user's mobile communication unit.

15. A method for an E-wallet managing server to inform the user of the balance of electronic money in the user's account designated by the phone number of the user's mobile communication unit and the password, comprising steps of:
receiving a request for informing the user of the balance of electronic money in the user's account from the user's ARS call wherein the user enters the phone number of his mobile communication unit and his password; and
referring to the balance of the user's account designated by the phone number of the user's mobile communication unit and the user's password; and
announcing a message including the referred balance of the user's account on the user's ARS call.

16. The method as claimed in claim 15 wherein said step of receiving the request further comprises a step of sending a message including the referred balance of the user's account to the user's mobile communication unit.

17. A method for an E-wallet managing server to inform the user of the balance of electronic money in the user's account designated by the phone number of the user's mobile communication unit and the password, comprising steps of:
taking the data including the phone number of the buyer's mobile communication unit, the buyer's password, and a request for informing the user of the balance of electronic money in the user's account when the user visits the homepage of the E-wallet managing server and enters said data on the web page;
referring to the balance of the user's account designated by the phone number of the user's mobile communication unit and the user's password; and
providing the referred balance of the user's account in the web page of the E-wallet managing server.

18. The method as claimed in claim 17 wherein said step of providing the referred balance further comprises a step of sending a message including the referred balance of the user's account to the user's mobile communication unit.

19. An electronic monetary system comprising:
an ARS server processing the issuance of electronic money, the recharging of an electronic account, the inquiry of the balance of the account, and the money transfer upon the request of an user on the ARS call;
an E-wallet managing server controlling the issuance of electronic money, the recharging of an electronic account, the inquiry of the balance of the account, and the money transfer;
a web server with homepage for interfacing the user for the transactions of said electronic money account on internet; and
a mobile communication unit with a function of electronic wallet, the phone number of which constitutes the electronic account with a corresponding password.

20. The electronic monetary system as claimed in claim 19 wherein said mobile communication unit comprises:
an encoding/decoding module for processing a data for wireless communication;
a memory module for storing the phone number, the password, the balance of account, and the details of the transaction;
an output module for displaying a data message for transactions of electronic money on wireless network;
an encryption/decryption module for secure data communication on the wireless network; and
a button for selection or a menu for the operation for an electronic wallet.

21. The electronic monetary system as claimed in claim 20 wherein said data processed by said encoding/decoding module comprises:
a designator stating the electronic wallet;
an OP code changing the status of the mobile communication unit;
an amount record corresponding to said OP code; and
an SMS message in correlation with said OP code.

22. The electronic monetary system as claimed in claim 20 wherein said data processed by said encoding/decoding module comprises:
a designator stating the electronic wallet;
an OP code corresponding to a specific transaction performed in the mobile communication unit;
an amount record corresponding to said OP code; and
an SMS message in correlation with said OP code.

23. A method for an E-wallet managing server to issue an amount of electronic money to a user, comprising steps of:
taking the data including the phone number of the user's mobile communication unit, the password, and the a requested amount of electronic money, which has been sent from the user's mobile communication unit having a function of electronic wallet, wherein the data of the requested amount of electronic money is provided by the user on the keypad button or from the menu;
sending a message for approval of the requested transaction to a server of the mobile communication company providing the mobile communication service;
opening a new electronic account with the requested amount of electronic money for the user wherein the corresponding amount of real money will be billed to the user by the mobile communication company; and
sending a message of the completion of the requested transaction with details including the balance of electronic money in the electronic account to the user's mobile communication unit.

24. A method for an E-wallet managing server to manage an electronic commerce between a first user and a second user, comprising steps of:
taking the data including the phone number of the first user's mobile communication unit, the first user's password, the phone number of the second user's mobile communication unit, and the requested amount of electronic money to be transferred from the server of the mobile communication company wherein the first user enters the data including the phone number of the second user's mobile communication unit and the requested amount of money to be transferred either on the button of the keypad or by menu of the first user's mobile communication unit having a function of electronic wallet so that the first user's mobile communication unit sends the data to the sever of the mobile communication company;
checking the balance of the first user's account designated by the phone number of the mobile communication unit;
sending a message for approval of the requested transaction of transferring electronic money between the first user's account and the second user's account to the server of the mobile communication company providing the mobile communication service; and
sending a message of the completion of the requested transaction with details including the balance of electronic money in the electronic account to the first user's and second user's mobile communication units.

25. A method for an E-wallet managing server either to issue or to recharge an amount of electronic money to a user, comprising steps of:
taking a request for issuing or recharging said amount of electronic money in the user's electronic account designated by the phone number of the mobile communication unit from the user's ARS call to the ARS server of the E-wallet managing server wherein the user enters the password and the requested amount of money;
opening or recharging the requested amount of electronic money to the user's account; and
sending a message of the completion of the requested transaction with details including the balance of electronic money in the electronic account.
